(19) United States
(12) Patent Application Publication
(10) Pub. No.: US 2026/0356076 A1
(43) Pub. Date: Nov. 12, 2026

(54) LAMINATE, SHAPED ARTICLE, MOLDED ARTICLE, METHOD FOR PRODUCING LAMINATE, METHOD FOR PRODUCING SHAPED ARTICLE, AND METHOD FOR PRODUCING MOLDED ARTICLE

(71) Applicant: Panasonic Intellectual Property Management Co., Ltd., Osaka (JP)

(72) Inventors: TOMONORI SUGIYAMA, Osaka (JP); KAZUHIKO KANEUCHI, Osaka (JP); HIROSHI MORIOKA, Osaka (JP); TAKASHI MORIMOTO, Osaka (JP)

(21) Appl. No.: 19/711,979

(22) Filed: Jun. 18, 2026

Related U.S. Application Data
(63) Continuation of application No. PCT/JP2024/036169, filed on Oct. 9, 2024.

(30) Foreign Application Priority Data
Dec. 26, 2023 (JP) 2023-219490

(51) Int. Cl. B32B 5/26; B29C 45/14; B29K 667/00; B32B 5/02; B32B 37/10; B32B 37/12; B32B 38/00

(52) U.S. Cl. CPC B32B 5/275; B29C 45/14065; B29C 45/1418; B32B 5/022; B32B 5/024; B32B 37/10; B32B 37/1207; B32B 37/1284; B32B 38/0004; B29C 2045/14147; B29K 2667/00; B32B 2037/1215; B32B 2250/02; B32B 2262/0276; B32B 2262/12; B32B 2262/124; B32B 2333/00; B32B 2367/00; B32B 2369/00

(57) ABSTRACT

A laminate is a laminate including a decorative layer, an adhesive layer, and a support layer laminated in this order, in which the support layer includes two or more kinds of materials having different melting points including a material having a relatively low melting point and a material having a relatively high melting point, and a 10% modulus value evaluated as tensile strength at an elongation rate of 10% in a tensile test according to JIS L1913 for a test piece having a width of 25 mm of the laminate is 5 N or more and 23 N or less.

### TECHNICAL FIELD

The present disclosure relates to a laminate, a shaped article, a molded article, a method for producing the laminate, a method for producing the shaped article, and a method for producing the molded article.

### BACKGROUND ART

In recent years, in exterior parts of home appliances, in-vehicle interior parts, and the like, there is an increasing need for decoration methods having a wide range of design expressions and high-quality designs due to diversification of customer orientation. As one of the decoration methods, there is an insert molding method in which a decorative material is positioned and fixed in an injection mold and integrated with an injected resin. By using this insert molding method, for example, it is possible to obtain a molded article using a decorative material made of a sheet, such as a veneer obtained by thinly slicing wood, or a decorative film printed on a thick substrate. On the other hand, in decoration of the conventional insert molding method, a plate shape having a relatively shallow product depth such as a panel is generally used, but in recent years, decoration into a deep drawn shape having a deep product depth is also required. Therefore, it is necessary to develop an insert molding method that has a high degree of design freedom and flexibly responds to customer demands. On the other hand, when insert molding the decorative material formed of these sheets, it is common to need a mechanism for fixing the decorative material to the injection mold, such as forming a positioning hole in a margin of an outer periphery of a product on the decorative material side and providing a pin for setting the positioning hole on the injection mold side. Note that the insert molding method defined in the present disclosure refers to a method of forming an entire product appearance surface with the decorative material, and includes a shape in which the decorative material is wound from the product appearance surface to a product back side depending on product specifications. The deep drawn shape refers to a shape in which a length (depth) in a vertical direction from a product end portion to a product bottom surface portion constituting a recess is 10 mm or more and 100 mm or less.

PTL 1 discloses a resin molded member using a composite sheet including a resin film, a nonwoven fabric, or the like. This configuration is illustrated in FIGS. 14 and 15.

Composite sheet 200 in FIG. 14 includes resin film 101, fabric material 102, resin film 103, and nonwoven fabric 104. Resin film 101 is formed on one side of fabric material 102 with a molten adhesive filling layer interposed therebetween, and resin film 103 and nonwoven fabric 104 are sequentially formed on the other side of fabric material 102 with the same molten adhesive filling layer interposed therebetween. As illustrated in FIG. 15, resin molded member 202 is formed by integrating a surface of composite sheet 200 on which nonwoven fabric 104 is formed and base resin 201 by injection molding.

PTL 2 discloses a composite sheet in which a woven fabric and a plastic sheet are integrated. This configuration is illustrated in FIGS. 16 and 17. Composite sheet 400 is formed by integrating woven fabric 301 and transparent hard acrylic resin sheet 303 with adhesive 302 interposed therebetween. Woven fabric 301 is impregnated with a thermoplastic resin, and composite sheet 400 is deformed into three-dimensional molded product 304 and then molded and integrated with the base resin to form composite three-dimensional molded product 305.

### CITATION LIST

### Patent Literature

PTL 1: Japanese U.S. Pat. No. 6,288,825
PTL 2: Unexamined Japanese Patent Publication No. 2012-218432

### SUMMARY OF THE INVENTION

In the conventional example of PTL 1, when composite sheet 200 and base resin 201 are integrated by injection molding, an adhesive layer (with base resin 201) formed on an outer surface of resin film 103 is prevented from melting and flowing out due to heat, pressure, or resin flow of base resin 201. However, due to a layer structure in which fabric material 102 is sandwiched between resin films 103, flexibility of composite sheet 200 itself depends on physical properties of resin films 103, and the flexibility is uniform without significant change during processing. Therefore, when deep drawing using a recessed mold or the like is required, it cannot follow force in a compression direction during deep drawing, and it is difficult to suppress compression wrinkles. For example, even if the deep drawing is performed in a state where a margin of product appearance of composite sheet 200 is fixed with a positioning pin or the like during fixing the mold, the material may gather due to compression of the product end portion, and wrinkles may occur. However, since composite sheet 200 has a certain strength due to the layer structure in which fabric material 102 is sandwiched between resin films 103, positioning accuracy with respect to the injection mold can be secured.

In the conventional example of PTL 2, processing followability as composite sheet 400 is improved by performing impregnation processing on woven fabric 301. However, since transparent hard acrylic resin sheet 303 itself has rigidity and flexibility does not change, similarly to PTL 1, when the deep drawing using the recessed mold or the like is required, it cannot follow the force in the compression direction during deep drawing, and it is difficult to suppress the compression wrinkles. On the other hand, as for the positioning accuracy, material rigidity to such an extent that positional deviation does not occur can be secured as in PTL 1.

As in these conventional examples, a material configuration having material rigidity capable of securing the positioning accuracy and having product shape followability during processing is devised for a plate-like shape having a relatively shallow product depth such as a panel. On the other hand, in the deep drawing, there remains a problem in a composite sheet material that has both flexibility for suppressing the wrinkles and rigidity for securing the positioning accuracy.

An object of the present disclosure is to provide a laminate capable of achieving both improvement in followability to the deep drawn shape and high positioning to the injection mold by changing flexibility of the laminate itself before and after processing.

A laminate according to the present disclosure is a laminate including a decorative layer, an adhesive layer, and a support layer laminated in this order, in which the support layer includes two or more kinds of materials having different melting points including a material having a relatively low melting point and a material having a relatively high melting point, and a 10% modulus value evaluated as tensile strength at an elongation rate of 10% in a tensile test according to JIS L1913 for a test piece having a width of 25 mm of the laminate is 5 N or more and 23 N or less.

A shaped article according to the present disclosure is a shaped article including a decorative layer, a first adhesive layer, and a support layer laminated in this order, in which the support layer includes two or more kinds of materials having different melting points including a material having a relatively low melting point and a material having a relatively high melting point, and a 10% modulus value evaluated as tensile strength at an elongation rate of 10% in a tensile test according to JIS L1913 for a test piece having a width of 25 mm of the shaped article is 30 N or more.

A molded article according to the present disclosure includes the shaped article and an injection molding resin integrated with the shaped article.

A molded article according to the present disclosure includes: one member selected from the group consisting of a resin member, a metal member, a glass member, a ceramic member, and a wooden member; and the shaped article bonded to a surface of the member.

A method for producing a laminate according to the present disclosure includes: sequentially laminating a decorative layer, a first adhesive layer, and a support layer including two or more kinds of materials having different melting points including a material having a relatively low melting point and a material having a relatively high melting point; and thermocompression bonding the decorative layer, the first adhesive layer, and the support layer laminated, so that a surface temperature of the support layer is equal to or lower than a melting point of the material having a relatively low melting point.

A method for producing a shaped article according to the present disclosure includes: trimming the laminate into a predetermined shape; and positioning, fixing, and hot pressing the laminate trimmed.

A method for producing a molded article according to the present disclosure includes: positioning and fixing the shaped article in injection molds, and clamping the injection molds; pouring a resin into a cavity between the injection molds in a state where the injection molds are clamped; and opening the injection molds after the resin is cured and taking out a molded article obtained by integrating the shaped article and the resin cured.

A method for producing a molded article according to the present disclosure includes obtaining a molded article obtained by bonding the shaped article to a surface of one member selected from the group consisting of a resin member, a metal member, a glass member, a ceramic member, and a wooden member.

According to the laminate according to the present disclosure, since the laminate having high flexibility can follow the force in the compression direction generated during deep drawing in hot pressing for forming the shaped body, occurrence of the compression wrinkles can be suppressed.

In addition, in the shaped article, simultaneously with the deep drawing, the material having a low melting point of the support layer constituting the laminate is melted by heat during hot pressing, and fused with the material having a high melting point constituting the support layer to form a crosslinked structure. As a result, hardness of the laminate after hot pressing in the shaped article is increased, and shape retainability and high positioning accuracy with respect to the injection molds can be secured.

### BRIEF DESCRIPTION OF THE DRAWINGS

FIG. 1A is a schematic sectional view illustrating a sectional structure of a laminate according to a first exemplary embodiment.

FIG. 1B is a SEM photograph (500 times) illustrating a crosslinked structure of a support layer in the laminate of FIG. 1A.

FIG. 2 is a schematic sectional view illustrating a sectional structure of a decorative film used as a decorative layer used for the laminate according to a first exemplary embodiment.

FIG. 3 is a schematic sectional view illustrating the sectional structure of the laminate in which a protective layer is formed on a surface of the laminate according to the first exemplary embodiment.

FIG. 4 is a schematic sectional view illustrating one step of a method for producing the laminate according to the first exemplary embodiment.

FIG. 5A is a plan view (1) illustrating a configuration in which the laminate according to the first exemplary embodiment is pre-trimmed into a predetermined shape and a sectional view (2) of the laminate before trimming.

FIG. 5B is a plan view (1) illustrating a configuration in which the laminate according to the first exemplary embodiment is pre-trimmed into a predetermined shape and a sectional view (2) of the laminate before trimming.

FIG. 6A is a schematic sectional view illustrating a state before hot pressing in a method for producing a shaped article according to the first exemplary embodiment.

FIG. 6B is a schematic sectional view illustrating the state before hot pressing in the method for producing the shaped article according to the first exemplary embodiment.

FIG. 7A is a schematic sectional view illustrating a state during hot pressing in the method for producing the shaped article according to the first exemplary embodiment.

FIG. 7B is a schematic sectional view illustrating the state during hot pressing in the method for producing the shaped article according to the first exemplary embodiment.

FIG. 8A is a schematic sectional view illustrating a state after hot pressing in the method for producing the shaped article according to the first exemplary embodiment.

FIG. 8B is a schematic sectional view illustrating the state after hot pressing in the method for producing the shaped article according to the first exemplary embodiment.

FIG. 9 is a view illustrating a 10% modulus value evaluated as tensile strength at an elongation rate of 10% in a tensile test according to JIS L1913 for the laminate according to Example 1 and a shaped body according to Example 2 in the first exemplary embodiment.

FIG. 10A is a schematic sectional view illustrating a molded article obtained by injection molding in a method for producing the molded article according to the first exemplary embodiment.

FIG. 10B is a schematic sectional view illustrating the molded article obtained by injection molding in the method for producing the molded article according to the first exemplary embodiment.

FIG. 11 is a schematic sectional view illustrating the sectional structure of the laminate according to a second exemplary embodiment.

FIG. 12 is a schematic sectional view illustrating the sectional structure of the laminate of another example according to the second exemplary embodiment.

FIG. 13 is a schematic sectional view illustrating a sectional structure of the molded article according to a third exemplary embodiment.

FIG. 14 is a schematic sectional view illustrating a sectional structure of a composite sheet of PTL 1.

FIG. 15 is a schematic sectional view illustrating a sectional structure of a resin molded member obtained by injection-molding the composite sheet of PTL 1.

FIG. 16 is a schematic sectional view illustrating the sectional structure of the composite sheet of PTL 2.

FIG. 17 is a schematic sectional view illustrating a sectional structure of a composite three-dimensional molded product obtained by injection-molding the composite sheet of PTL 2.

### DESCRIPTION OF EMBODIMENT

A laminate according to a first aspect is a laminate including a decorative layer, a first adhesive layer, and a support layer laminated in this order, in which the support layer includes two or more kinds of materials having different melting points including a material having a relatively low melting point and a material having a relatively high melting point, and a 10% modulus value evaluated as tensile strength at an elongation rate of 10% in a tensile test according to JIS L1913 for a test piece having a width of 25 mm of the laminate is 5 N or more and 23 N or less.

In the laminate according to a second aspect, in the first aspect, the material having a relatively low melting point included in the support layer may be fused between the materials having a relatively high melting point included in the support layer to form a crosslinked structure.

In the laminate according to a third aspect, in the first or second aspect, the first adhesive layer may penetrate into the support layer and be bonded and integrated with the support layer, and the first adhesive layer may cover a surface of the support layer.

In the laminate according to a fourth aspect, in any one of the first to third aspects, a base material layer may be formed between the decorative layer and the first adhesive layer.

A shaped article according to a fifth aspect is a shaped article including a decorative layer, a first adhesive layer, and a support layer laminated in this order, in which the support layer includes two or more kinds of materials having different melting points including a material having a relatively low melting point and a material having a relatively high melting point, and a 10% modulus value evaluated as tensile strength at an elongation rate of 10% in a tensile test according to JIS L1913 for a test piece having a width of 25 mm of the shaped article is 30 N or more.

In the shaped article according to a sixth aspect, in the fifth aspect, the material having a relatively low melting point included in the support layer may be fused between the materials having a relatively high melting point included in the support layer to form a crosslinked structure, and a shape of the shaped article may be maintained.

In the shaped article according to a seventh aspect, in the fifth or sixth aspect, a product depth expressed as a length from an opening surface of a recess to a bottom of the recess of the laminate constituting the shaped article may be 10 mm or more and 100 mm or less.

A molded article according to an eighth aspect includes: the shaped article according to any one of the fifth to seventh aspects; and an injection molding resin integrated with the shaped article.

A molded article according to a ninth aspect includes: one member selected from the group consisting of a resin member, a metal member, a glass member, a ceramic member, and a wooden member; and the shaped article according to any one of the fifth to seventh aspects, the shaped article being bonded to a surface of the member.

A method for producing a laminate according to a tenth aspect includes: sequentially laminating a decorative layer, a first adhesive layer, and a support layer including two or more kinds of materials having different melting points including a material having a relatively low melting point and a material having a relatively high melting point; and thermocompression bonding the decorative layer, the first adhesive layer, and the support layer laminated, so that a surface temperature of the support layer is equal to or lower than a melting point of the material having a relatively low melting point.

In the method for producing the laminate according to an eleventh aspect, in the tenth aspect, for a test piece having a width of 25 mm of the laminate obtained in the thermocompression bonding, a 10% modulus value evaluated as tensile strength at an elongation rate of 10% in a tensile test according to JIS L1913 may be 5 N or more and 23 N or less.

A method for producing a shaped article according to a twelfth aspect includes: trimming the laminate according to any one of the first to fourth aspects into a predetermined shape; and positioning, fixing, and hot pressing the laminate trimmed.

In the method for producing the shaped article according to a thirteenth aspect, in the twelfth aspect, for a test piece having a width of 25 mm of the shaped article obtained in the hot pressing, a 10% modulus value evaluated as tensile strength at an elongation rate of 10% in a tensile test according to JIS L1913 may be 30 N or more.

A method for producing a molded article according to a fourteenth aspect includes: positioning and fixing the shaped article according to any one of the fifth to seventh aspects in injection molds, and clamping the injection molds; pouring a resin into a cavity between the injection molds in a state where the injection molds are clamped; and opening the injection molds after the resin is cured and taking out a molded article obtained by integrating the shaped article and the resin cured.

A method for producing a molded article according to a fifteenth aspect includes obtaining a molded article obtained by bonding the shaped article according to any one of the fifth to seventh aspects to a surface of one member selected from the group consisting of a resin member, a metal member, a glass member, a ceramic member, and a wooden member.

Hereinafter, the laminate, the shaped article, the molded article, and the method for producing the same according to exemplary embodiments of the present disclosure will be described with reference to the accompanying drawings. Note that substantially the same members are denoted by the same reference marks in the drawings.

### First Exemplary Embodiment

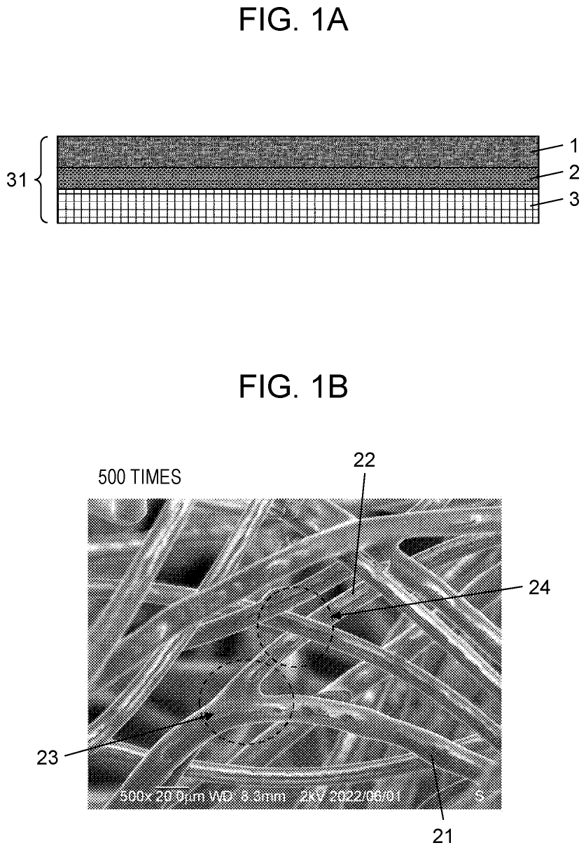

FIG. 1A is a schematic sectional view illustrating a sectional structure of laminate 31 according to a first exemplary embodiment. FIG. 1B is a SEM photograph (500 times) illustrating the crosslinked structure of the support layer in the laminate of FIG. 1A. As illustrated in FIG. 1A, laminate 31 includes decorative layer 1, first adhesive layer 2, and support layer 3 laminated in this order. As illustrated in FIG. 1B, support layer 3 includes two or more kinds of materials having different melting points including a material having a relatively low melting point and a material having a relatively high melting point.

According to the laminate according to the first exemplary embodiment, hardness of the support layer changes before and after heat treatment such as hot pressing for obtaining the shaped article. That is, during hot pressing, occurrence of wrinkles is suppressed by deep drawing on a flexible laminate, and after hot pressing, the hardness of the support layer is increased by the crosslinked structure formed by the material having a relatively low melting point contained in the support layer melting to be fused between the materials having a relatively high melting point contained in the support layer, and a shaped article maintaining a predetermined shape can be obtained.

When the adhesive layer penetrates into the support layer and is bonded and integrated by an anchor effect, the adhesive layer covers the surface of the support layer, and the adhesive layer itself easily follows a shape of the support layer in the shaped article after hot pressing. Furthermore, the decorative layer similarly follows the shape through the adhesive layer. As a result, shape followability of the laminate itself is improved, and shape retainability of the shaped article after hot pressing is improved by an effect of improving the hardness of the support layer itself described above.

Furthermore, by directly fixing the shaped article having a retained shape to the injection molds, the shaped article can be accurately aligned with the injection mold, and can be molded and integrated with a base resin.

Hereinafter, members constituting the laminate will be described.

### Decorative Layer

Decorative layer 1 is not limited as long as it is a decorative material generally used, such as fabric, natural wood, leather, and a decorative film. A thickness of decorative layer 1 is not particularly limited depending on characteristics of the decorative material, but is, for example, in a range of 0.1 mm or more and 3.0 mm or less. When the thickness of decorative layer 1 is in the above range, handleability is good, and defects such as wrinkles and tears during processing are less likely to occur. When the thickness of decorative layer 1 is in the above range, hardness of an entire laminate is suppressed to be low, bendability is maintained, and followability to a product shape is obtained.

### Decorative Film

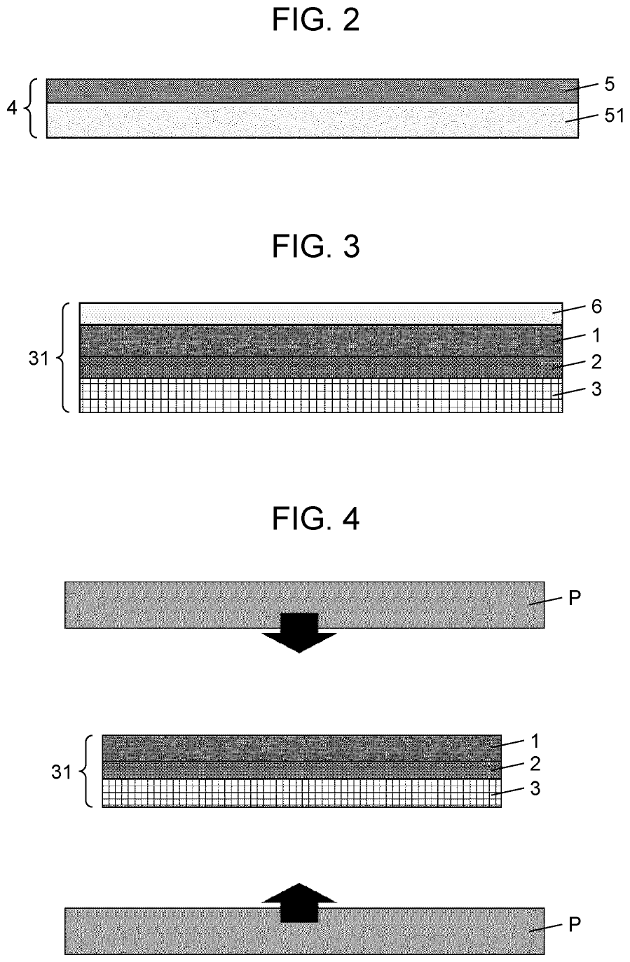

FIG. 2 is a schematic sectional view illustrating a sectional structure of decorative film 4 used as decorative layer 1 used for the laminate according to the first exemplary embodiment. Decorative film 4 is formed by forming decorative pattern layer 5 on a surface of base material 51. Decorative film 4 is produced using a known printing and coating method such as inkjet printing, gravure printing, screen printing, or a roll coater, and is formed as decorative pattern layer 5 having an arbitrary color or pattern according to a customer request. Base material 51 of decorative film 4 may be formed of, for example, a general film material such as a polyethylene terephthalate resin, an acrylic resin, or a polycarbonate resin, and is not particularly limited. An average thickness of base material 51 is, for example, 20 μm or more and 300 μm or less. When the average thickness of base material 51 is in the above range, wrinkles, tears, and warpage are less likely to occur in the base material 51 even in thermal drying or the like in a process of forming decorative pattern layer 5, and the base material is easy to handle. The decorative film itself has good followability to the product shape. Furthermore, in the case of being produced as a film roll, since a film thickness of base material 51 is in the above range, an entire weight is not heavy, handling during transportation or the like is good, and production cost can also be suppressed low. In addition to the pattern layer, a functional layer such as an electronic wiring produced using a known printing and coating method or an image display layer may be formed on decorative pattern layer 5. As described above, an arbitrary color, pattern, and function can be formed on decorative layer 1 according to the customer request.

### Protective Layer

Note that in consideration of durability, protective layer 6 may be formed on an outermost surface of decorative layer 1 as illustrated in FIG. 3. When protective layer 6 is formed, a film thickness thereof is, for example, in a range of 3 μm or more and 100 μm or less. When the film thickness is in the above range, the protective layer easily follows irregularities of a material surface, pinholes are less likely to occur, and a function as protective layer 6 can be sufficiently exhibited. In addition, an appearance derived from the protective layer 6 does not appear, and texture of decorative layer 1 is less likely to be impaired. However, as long as a desired effect can be obtained, there is no problem even if the film thickness is out of the above range. Furthermore, a filler, a colorant, or the like can also be added to protective layer 6 itself.

### First Adhesive Layer

First adhesive layer 2 has a role of bonding decorative layer 1 and support layer 3. First adhesive layer 2 is made of, for example, a resin such as a vinyl chloride-vinyl acetate-based copolymer, an olefin-based resin, a polyolefin-based resin, a urethane-based resin, or an acrylic resin, and is formed in a form that completely covers the surface of support layer 3. A material of first adhesive layer 2 is not limited as long as it can bond decorative layer 1 and support layer 3 to each other. An average film thickness of first adhesive layer 2 is, for example, 2 μm or more and 200 μm or less. When the average film thickness of first adhesive layer 2 is in the above range, film strength of first adhesive layer 2 itself is sufficiently obtained, and occurrence of peeling defects such as cohesive fracture can be suppressed. Furthermore, adhesive thickness is also sufficient, and sufficient adhesive strength to decorative layer 1 and support layer 3 can be obtained. In addition, when the average film thickness of first adhesive layer 2 is in the above range, the production cost can also be suppressed low. The film thickness of 3 μm or more and 100 μm or less is more preferable in consideration of a balance between the film strength and adhesive strength and the production cost. In addition, a permeation membrane thickness of first adhesive layer 2 to support layer 3 (due to the anchor effect) is preferably 5 μm or more. When the thickness is less than 5 μm, the adhesive strength to support layer 3 is insufficient, and interface peeling failure may occur. A process of forming first adhesive layer 2 is not limited depending on handling form of the first adhesive layer. When first adhesive layer 2 is handled in a liquid state, first adhesive layer 2 may be formed in advance on decorative layer 1 side or may be formed in advance on support layer 3 side, by using a known printing/coating process such as spray spraying, roll coater, or inkjet coating. Alternatively, when first adhesive layer 2 is handled in a solid state such as a sheet, first adhesive layer 2 may be bonded to decorative layer 1 in advance and then bonded to support layer 3, or conversely, first adhesive layer 2 may be bonded to support layer 3 in advance and then bonded to decorative layer 1. Furthermore, decorative layer 1, first adhesive layer 2, and support layer 3 may be bonded simultaneously. When first adhesive layer 2 is formed in a form that completely covers the surface of support layer 3, followability to support layer 3 can be improved, and the coated portion is less likely to allow air to pass therethrough, so that laminate 31 can be directly positioned and fixed to a surface of the injection mold using a vacuum suction mechanism. Furthermore, the coated portion serves as a barrier layer, and reduces seepage of the injection molding resin onto a surface of laminate 31.

### Support Layer

Support layer 3 plays a role of improving strength of laminate 31 itself by thermocompression bonding, and holding laminate 31 in a predetermined processed shape. In addition, since first adhesive layer 2 is formed in a form that completely covers support layer 3, and decorative layer 1 is formed with first adhesive layer 2 interposed therebetween, strength improvement of support layer 3 itself effectively acts on strength improvement and shape retainability of laminate 31 itself. That is, laminate 31 itself can be made self-standing, and can be positioned to the molds at the time of producing the shaped article and at the time of producing the molded article, and a post-processing step can be made unnecessary.

A material, structure, thickness, and the like of support layer 3 can be selected according to application. Support layer 3 includes two or more kinds of materials having different melting points including a material having a relatively low melting point and a material having a relatively high melting point. As an example, when the material is a polyethylene terephthalate-based material, a weight ratio of polyethylene terephthalate short fibers having an average fineness of 0.6 to 3.3 dtex (decitex) and heat-fusible polyester short fibers having a core-sheath structure including a low melting point component is 10/90 to 90/10 (Example 1).

As a process for producing the support layer, fibers spun from a card spinning machine may be folded obliquely crosswise to form a web, and after fiber entanglement by a needle punch machine, the heat-fusible polyester short fibers may be further melted by a heat treatment device to form a nonwoven fabric sheet as the support layer. The heat-fusible polyester short fiber having a core-sheath structure is a composite fiber having a core-sheath structure in which a core portion is polyethylene terephthalate that is a material having a high melting point and a sheath portion is copolymerized polyester that is a material having a low melting point. A melting point of the material having a low melting point of the sheath portion in the heat-fusible polyester short fiber is preferably in a range of 100 °C to 160 °C so that molding can be performed even when a temperature of the mold is relatively low.

When the nonwoven fabric is used for support layer 3, a multilayer structure in which layers are deformable in a shearing direction is formed. Thus, the layers of the support layer 3 are deformed in the shear direction against tensile deformation and compressive deformation generated during hot pressing, and serve as a cushioning material, so that the wrinkles and tears of laminate 31 can be suppressed. The number of layers of the multilayer structure is preferably 5 to 30. When the number of layers is less than 5, a range that can be deformed in the shearing direction is narrowed, and an effect on the wrinkles and tears of laminate 31 is reduced. On the other hand, when the number of layers is more than 30, laminate 31 itself is too thick, and thus a circumferential length difference during bending is large, and it is difficult to sufficiently follow the product shape. In consideration of the effect on the wrinkles and tears, and bending workability, the number of layers of the multilayer structure is more preferably 10 to 20. However, the number of layers of the multilayer structure is not limited as long as the above-described effect can be obtained.

As illustrated in FIG. 1B, the copolymerized polyester which is the material having a low melting point of the sheath portion of heat-fusible polyester short fiber 21 having a core-sheath structure is thermally melted by thermocompression bonding, and is fused with another heat-fusible polyester short fiber 21 or polyethylene terephthalate short fiber 22 to form the crosslinked structure. Note that as illustrated in FIG. 1B, in an entire support layer, all the copolymerized polyester which is the material having a low melting point does not have to be thermally melted, and fusion-bonded portion 23 and non-fusion-bonded portion 24 may be present.

Furthermore, the weight ratio of the used fibers in support layer 3 described in Example 1 is, for example, polyethylene terephthalate short fibers/heat-fusible polyester short fibers having a core-sheath structure=10/90 to 90/10, and more preferably 30/70 to 70/30. When the weight ratio of the heat-fusible polyester short fibers having a core-sheath structure is within the above range, the texture is maintained at an appropriate hardness, mold followability is good, and sufficient molding accuracy is obtained. Furthermore, since a processing temperature by the heat treatment device also affects the texture of the nonwoven fabric, processing at 100 °C to 160 °C is preferable, but the processing temperature is not necessarily limited to this processing temperature range when the mold followability is good and sufficient molding accuracy is obtained.

Note that in Example 1, as the polyethylene terephthalate-based material, a hybrid combination of the polyethylene terephthalate short fiber that is the material having a high melting point and the heat-fusible polyester short fiber having a core-sheath structure including a core portion made of a material having a high melting point and a sheath portion made of a material having a low melting point has been described, but the polyethylene terephthalate-based material is not limited thereto. The heat-fusible polyester short fiber having a core-sheath structure is a so-called composite fiber including the material having a high melting point and the material having a low melting point in one fiber. The fibers contained in the support layer may be basically a combination of the material having a low melting point and the material having a high melting point without using a composite fiber such as a core-sheath structure. In addition, as described above, the material, the structure, and the like can be selected according to the application. For example, fibers such as nylon, polypropylene, and polyethylene may be used as raw materials, or different raw materials may be used in combination. Furthermore, a fiber structure of the composite fiber may be formed by a sea-island structure, a side-by-side structure, or the like instead of the core-sheath structure. Furthermore, a plurality of types of composite fibers may be used in combination. In addition, a method of thermocompression bonding is not limited as long as it can satisfy a role of the support layer 3 that improves the strength of laminate 31 itself by thermocompression bonding and holds laminate 31 in a predetermined processed shape.

### Flexibility (Modulus Value) of Laminate

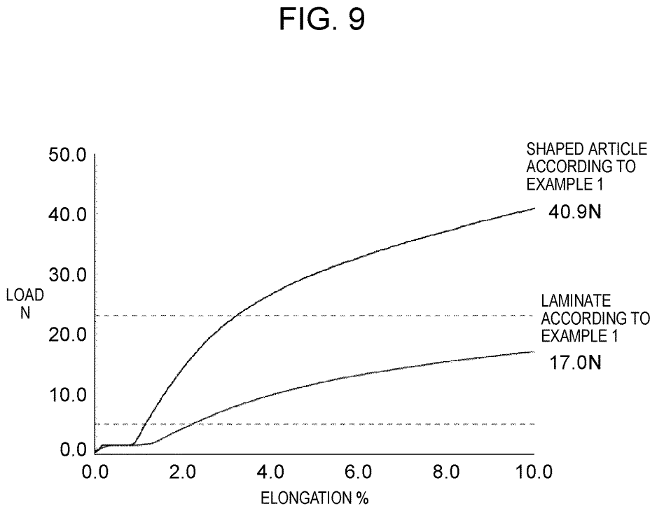

FIG. 9 is a view illustrating a 10% modulus value evaluated as tensile strength at an elongation rate of 10% in a tensile test according to JIS L1913 for the laminate according to Example 1 and a shaped body according to Example 2 in the first exemplary embodiment. In FIG. 9, a horizontal axis represents the elongation rate (%), and a vertical axis represents a load (N). As illustrated in FIG. 9, when the load is applied to the test piece, the test piece stretches. The load at a time when the elongation rate is 10% is the 10% modulus value.

As described above, in laminate 31, decorative layer 1, first adhesive layer 2, and support layer 3 are formed in this order, and flexibility of laminate 31 before and after hot pressing is greatly affected by flexibility of support layer 3. The flexibility of laminate 31 is evaluated using the 10% modulus value evaluated as tensile strength at an elongation rate of 10% in a tensile test according to JIS L1913. The modulus value is used to evaluate how much load is required for a predetermined elongation (10% in this case). In the case of laminate 31, degree of curing of support layer 3 can be evaluated. For example, when fusion between the material having a low melting point and the material having a high melting point constituting support layer 3 does not sufficiently proceed, since the fibers of the support layer 3 are easily deformed, a load required for the predetermined elongation decreases, and as a result, the modulus value of laminate 31 is relatively small. On the other hand, when the fusion between the material having a low melting point and the material having a high melting point constituting support layer 3 sufficiently proceeds by heat of hot pressing, the fibers of support layer 3 are fused to each other to form the crosslinked structure. Therefore, since the deformation is less likely to occur, the load required for the predetermined elongation increases, and as a result, the modulus value of laminate 31 is relatively large. In this manner, by evaluating the modulus value, the degree of curing of support layer 3 can be confirmed, and the modulus value can be used as an index for confirming the flexibility of laminate 31.

In the case of processing into the above-described deep drawn shape, the 10% modulus value of laminate 31 before hot pressing is preferably 5 N or more and 23 N or less (tensile test according to JIS L 1913, test piece width 25 mm, modulus value at 10% elongation). More specifically, it is preferably 8 N or more and 20 N or less, and particularly when it is 8 N or more and 17 N or less, the followability is further improved with respect to shape deformation during deep drawing, and an effect of suppressing compression wrinkles during processing can be greatly expected. When it is smaller than 5 N, the flexibility is too high, and thus it is difficult to set the device during shaping processing. On the other hand, when it is larger than 23 N, the flexibility of laminate 31 is impaired, and the shape followability is deteriorated.

When the relative degree of curing based on the 10% modulus value of laminate 31 in the shaped body after hot pressing is 100%, the relative degree of curing of the 10% modulus value of laminate 31 before hot pressing (10% modulus value of laminate before hot pressing/10% modulus value of laminate in shaped body after hot pressing) is preferably 15% or more and 80% or less. Furthermore, the relative degree of curing is preferably 20% or more and 70% or less, and particularly when the relative degree of curing is 20% or more and 60% or less, it is easier to follow the shape deformation during processing. When the relative degree of curing is less than 15%, it is difficult to set the device during shaping processing as described above. On the other hand, when the degree of curing is more than 80%, the flexibility of laminate 31 is impaired, and the shape followability is deteriorated.

A state in which laminate 31 has flexibility and high followability is a state in which the fibers constituting support layer 3 can be deformed independently. That is, when deformation occurs during deep drawing, the fibers can be freely deformed and moved, so that stress of the deformation can be alleviated only by support layer 3. Therefore, occurrence of the compression wrinkles can be suppressed. On the other hand, when the fibers constituting support layer 3 are fused and fixed by the crosslinked structure, the fibers cannot move freely, and support layer 3 is deformed as if it were a uniform single object. When the deep drawing is performed in this state, compressive deformation generated in support layer 3 is directly transmitted to decorative layer 1 via first adhesive layer 2, and as a result, a wrinkle appearance defect occurs on the surface of decorative layer 1. As an index of the flexibility of laminate 31, the above modulus value and a range of the relative degree of curing are described, but the modulus value and the relative degree of curing are not limited to values outside the above range as long as the desired effect can be obtained.

### Method for Producing Laminate

Next, a molding process (production method) of laminate 31 will be described.

FIG. 4 is a schematic sectional view illustrating one step of the method for producing laminate 31 according to the first exemplary embodiment.

FIG. 4 illustrates a laminate state in which decorative layer 1 and support layer 3 are integrated by thermocompression bonding with first adhesive layer 2 interposed therebetween. Laminate 31 is formed using a thermocompression bonding device P capable of applying heat and pressure. Examples of thermocompression bonding device P include known devices such as a general-purpose press device that applies pressure with upper and lower heated plates, a multi-stage press device, a vacuum laminator device, and a roll-to-roll press device.

When laminate 31 is produced using thermocompression bonding device P, it is preferable that the modulus value and the relative degree of curing of laminate 31 fall within the above-described ranges. Therefore, it is necessary to adjust an amount of heat applied to support layer 3. As an index thereof, the surface temperature of support layer 3 immediately after thermocompression bonding is preferably a temperature equal to or lower than the melting point of the material having a low melting point constituting support layer 3. The temperature immediately after thermocompression bonding refers to a temperature when a processing portion of thermocompression bonding device P is completely separated from the surface of laminate 31. When support layer 3 is finished at a temperature equal to or higher than the melting point, fusion between the material having a low melting point and the material having a high melting point constituting support layer 3 proceeds, and the hardness of support layer 3 increases. Examples of adjustment parameters of the amount of heat applied to support layer 3 include a surface temperature of the processing portion, pressure, and time in the case of using a general-purpose press device, and include a surface temperature of a heating roll, contact pressure between rolls, conveyance speed, and tension of the material in the case of using a roll-to-roll press device. Although specific adjustment parameters of the amount of heat and setting values are different depending on thermocompression bonding device P to be selected, combination thereof is not limited as long as the surface temperature of support layer 3 immediately after thermocompression bonding is a temperature equal to or lower than the melting point of the material having a low melting point constituting support layer 3. Laminate 31 manufactured in this manner has flexibility before hot pressing, and can follow the deep drawn shape during hot pressing.

### Molding Process of Laminate

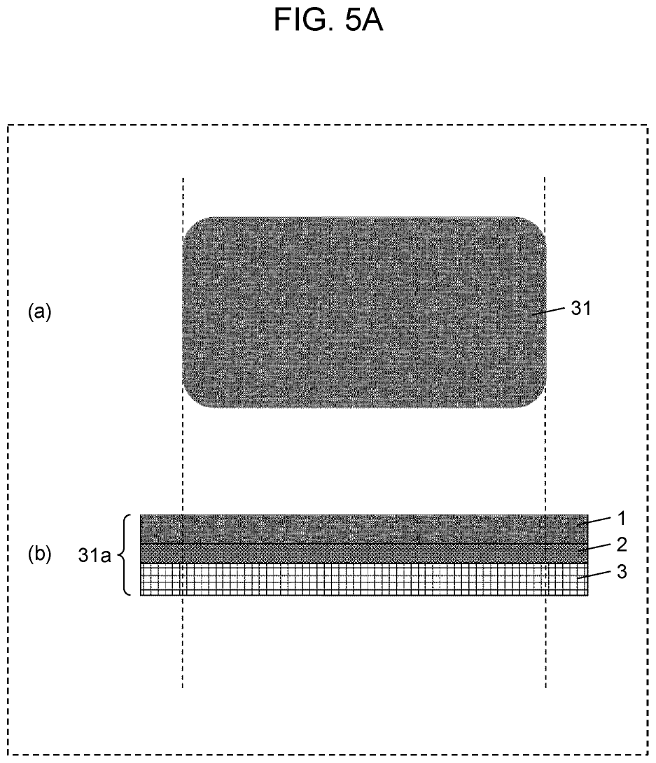

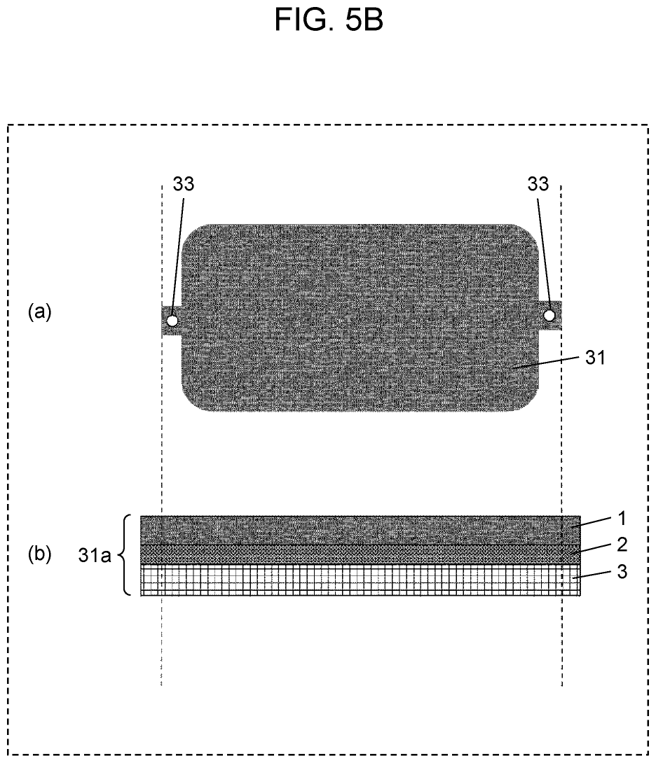

Part (a) of FIG. 5A is a plan view illustrating a configuration in which laminate 31 according to the first exemplary embodiment is pre-trimmed into a predetermined shape without using a positioning tab, and part (b) of FIG. 5A is a sectional view of the laminate before trimming. Part (a) of FIG. 5A is a plan view illustrating a configuration in which laminate 31 according to the first exemplary embodiment is pre-trimmed into a predetermined shape using positioning tab 33, and part (b) of FIG. 5A is a sectional view of the laminate before trimming.

FIG. 5A(a) and 5B(a) illustrate laminate 31 pre-trimmed to a shape in consideration of irregularities and bending of the product shape. Examples of a trimming method include shape punching using a Thomson type, laser cutting, and hand cutting, but are not limited as long as trimming into a predetermined product shape can be performed. When trimming is performed into a predetermined product shape at an initial stage of the molding process, it is not necessary to provide a positioning portion in a margin other than the product shape, and post-processing after hot pressing is unnecessary. Alternatively, on the premise that laminate 31 after hot pressing has hardness capable of securing the positioning accuracy with respect to the injection mold, as illustrated in part (a) of FIG. 5B, minimum positioning tab 33 or the like can be provided.

### Example 1

In the laminate according to Example 1, for example, a polyester-based woven fabric as the decorative layer and a polyester-based nonwoven fabric (basis weight: 90 g/m²) as the support layer are integrated by thermocompression bonding with an olefin-based hot-melt as the first adhesive layer interposed therebetween.

As processing conditions of the laminate, the above materials were laminated, and the laminate was obtained at a temperature of 160 °C, a speed of 5.2 m/min, and a pressure of 0.7 MPa in a roll-to-roll processing device.

For the obtained laminate according to Example 1, the 10% modulus value evaluated as tensile strength at an elongation rate of 10% in a tensile test according to JIS L1913 was 17.0 N as illustrated in FIG. 9.

### Method for Producing Shaped Article

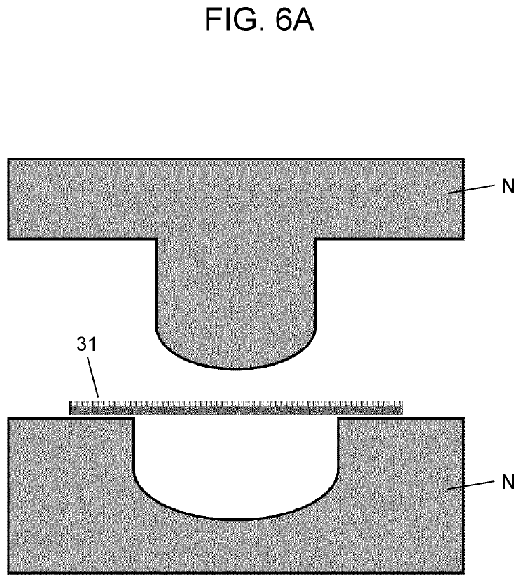

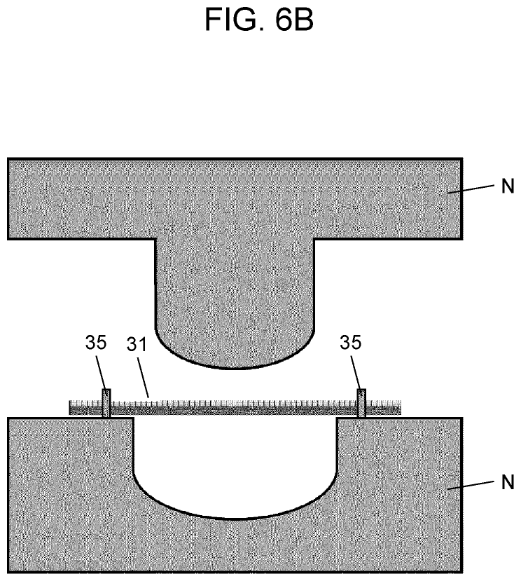

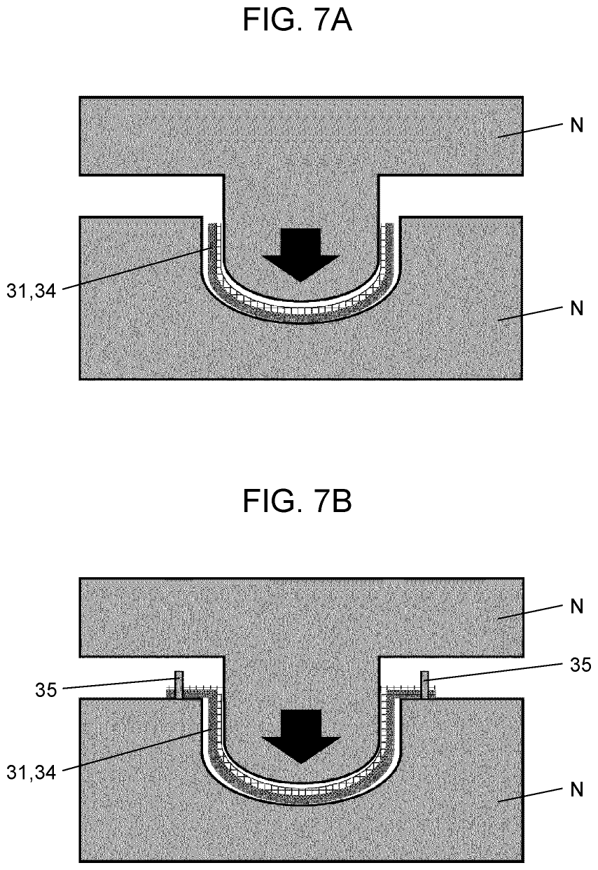

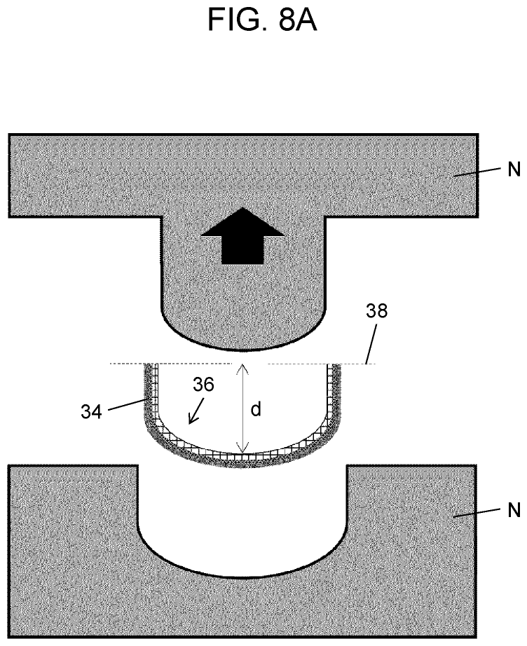

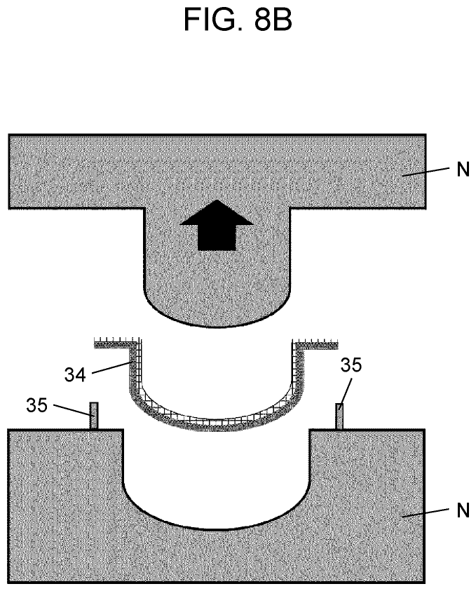

FIGS. 6A and 6B are schematic sectional views illustrating a state before hot pressing in the method for producing the shaped article according to the first exemplary embodiment. FIGS. 7A and 7B are schematic sectional views illustrating a state during hot pressing in the method for producing the shaped article according to the first exemplary embodiment. FIGS. 8A and 8B are schematic sectional views illustrating a state after hot pressing in the method for producing the shaped article according to the first exemplary embodiment.

FIGS. 6A and 6B illustrate a state in which pre-trimmed laminate 31 is provided on a processing surface of hot pressing machine N before hot pressing. In laminate 31 of FIG. 6A, laminate 31 can be provided on the processing surface of hot pressing machine N using, for example, a positioning mechanism such as an L-shaped bracket along a shape of trimmed laminate 31. Alternatively, as illustrated in FIG. 6B, laminate 31 can be provided by inserting positioning pin 35 of hot pressing machine N into positioning tab 33 provided on laminate 31.

FIGS. 7A and 7B illustrate shaped article 34 obtained by hot pressing laminate 31 by hot pressing machine N and shaping the laminate into a predetermined product shape. FIG. 7B illustrates a state in which positioning tab 33 provided on laminate 31 and positioning pin 35 of hot pressing machine N are used. At this time, laminate 31 is heated by heat conduction from the processing surface of hot pressing machine N. First adhesive layer 2 has improved flexibility due to the heat, and thus is easily deformed. Accordingly, decorative layer 1 and support layer 3 adhering to first adhesive layer 2 at their interfaces are also easily deformed. In addition, among the materials constituting support layer 3, the material having a low melting point is thermally melted by heating, and thus penetrates between the materials having a high melting point and fuses with them to form the crosslinked structure. Since the crosslinked structure is formed, the hardness of support layer 3 increases. Since a process of forming the crosslinked structure and a process of hot pressing into the product shape proceed simultaneously in parallel, followability of support layer 3 to the product shape is improved, and shape retainability is improved due to the increased hardness. As a result, laminate 31 changes to shaped article 34 having a predetermined product shape, and shape followability to the product shape and the shape retainability are improved. Note that the processing temperature during hot pressing is not limited as long as it is in a temperature range that promotes flexibility of first adhesive layer 2 and support layer 3 and formation of the crosslinked structure, but is preferably in a temperature range of 80 °C or higher.

After hot pressing in FIGS. 8A and 8B, the crosslinked structure formed in support layer 3 in FIGS. 7A and 7B is maintained, and shaped article 34 having a shape retained in the product shape is obtained even after being taken out from the processing surface of hot pressing machine N.

### Shaped Article

Shaped article 34 is configured by laminating the decorative layer, the first adhesive layer, and the support layer in this order. Among them, the support layer includes two or more kinds of materials having different melting points including a material having a relatively low melting point and a material having a relatively high melting point. The modulus value of shaped article 34 is preferably 30 N or more and 100 N or less (tensile test according to JIS L1913, test piece width 25 mm, modulus value at 10% elongation). More specifically, the modulus value is preferably 30 N or more and 80 N or less, and particularly when the modulus value is 30 N or more and 60 N or less, it can cope with positioning and fixing to the injection mold and material deformation associated with resin flow during injection molding. When the modulus value is smaller than 30 N, accuracy of positioning and fixing to the injection mold is impaired, and when the modulus value is larger than 100 N, it cannot cope with the material deformation associated with the resin flow during injection molding, and there is a possibility that shaped article 34 is damaged, such as cracked.

The material having a low melting point included in the support layer may be fused between the materials having a high melting point included in the support layer to form the crosslinked structure, and the shape may be maintained.

Furthermore, as illustrated in FIG. 8A, product depth d expressed as a length from opening surface 38 of recess 36 of the laminate constituting shaped article 34 to the bottom of the recess may be 10 mm or more and 100 mm or less. Note that recess 36 is defined by three surfaces in FIG. 8A, but is not limited thereto. For example, the recess may be formed of two adjacent surfaces at an angle. Surfaces constituting the recess may be curved surfaces instead of flat surfaces.

### Example 2

In the shaped article according to Example 2, for example, the laminate according to Example 1 was hot pressed at a temperature of 90 °C under hot pressing conditions of standby at a bottom dead center for 30 seconds to obtain the shaped article.

For the obtained shaped article according to Example 2, the 10% modulus value evaluated as tensile strength at an elongation rate of 10% in a tensile test according to JIS L1913 was 40.9 N as illustrated in FIG. 9.

### Method for Producing Molded Article

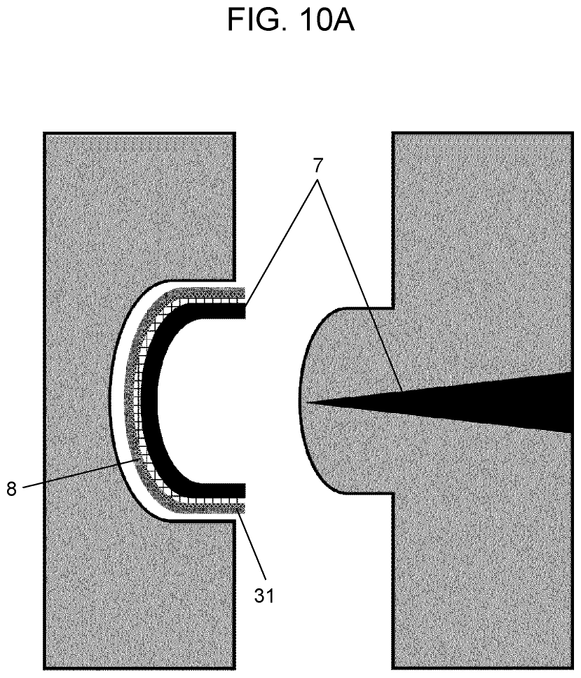

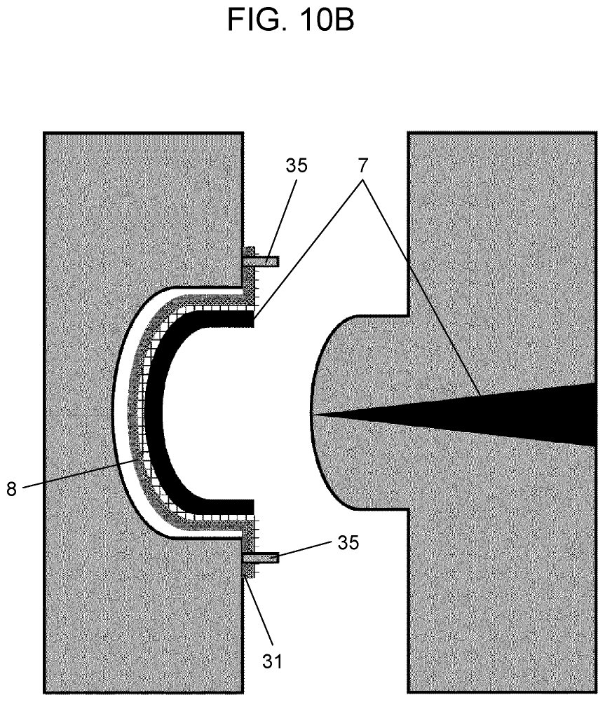

FIGS. 10A and 10B are schematic sectional views illustrating molded article 8 obtained by injection molding in the method for producing the molded article according to the first exemplary embodiment. Next, during injection molding in FIG. 10A, molded article 8 having shaped article 34 on a product appearance surface can be obtained by providing shaped article 34 so as to be fitted into a product shape portion of the injection mold and molding and integrating the shaped article with base resin 7. Note that as illustrated in FIG. 9B, shaped article 34 may be provided by fitting positioning tab 33 of shaped article 34 onto positioning pin 35 of the injection mold. Examples of base resin 7 include general-purpose molded resins such as a PMMA resin, an ABS resin, a PS resin, and a PC resin. In addition, it is also possible to cope with resins that require molding at a high temperature, such as resins for optical application and super engineering resins. Note that shaped article 34 is self-standing, has high shape retainability, and can be positioned in the molds, and as illustrated in FIG. 5, it is pre-trimmed to correspond to the molded article at laminate 31 stage before hot pressing in FIG. 6, and thus the obtained molded article 8 does not require the post-processing.

Note that although molded article 8 in FIG. 10A or FIG. 10B illustrates a state in which only the appearance surface is covered with decorative layer 1, it is also possible to obtain a molded article in which shaped article 34 is wound not only on the appearance surface but also on an appearance back surface side by forming a fold in an end surface of shaped article 34 during hot pressing illustrated in FIGS. 8A and 8B and then molding and integrating shaped article 34 and base resin 7 with the fold as a starting point during injection molding. A length, an angle, and the like of the fold can be changed according to a target product shape. As described above, by designing a mold structure according to the product shape and using the process of the present disclosure, a method for finishing the product shape can also be arbitrarily supported. As described above, by designing the mold structure according to the product shape and using the process according to the present disclosure, the method for finishing the product shape can also be arbitrarily supported. In particular, when the trimming is performed into a predetermined product shape at the initial stage of the molding process, it is not necessary to provide the positioning portion in the margin portion other than the product shape, and thus, even in the process of winding laminate 31 up to the appearance back surface side described above, the post-processing can be unnecessary.

### Second Exemplary Embodiment

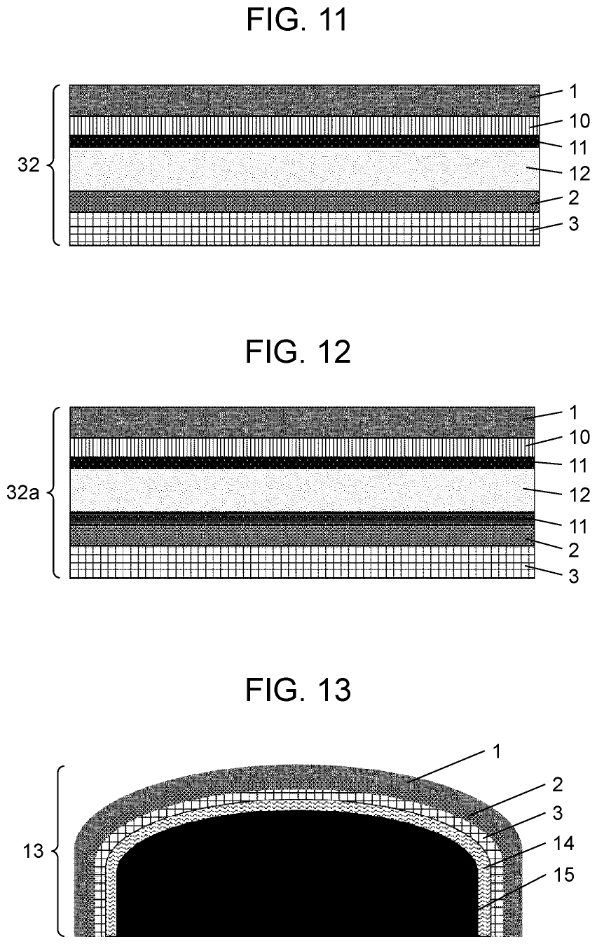

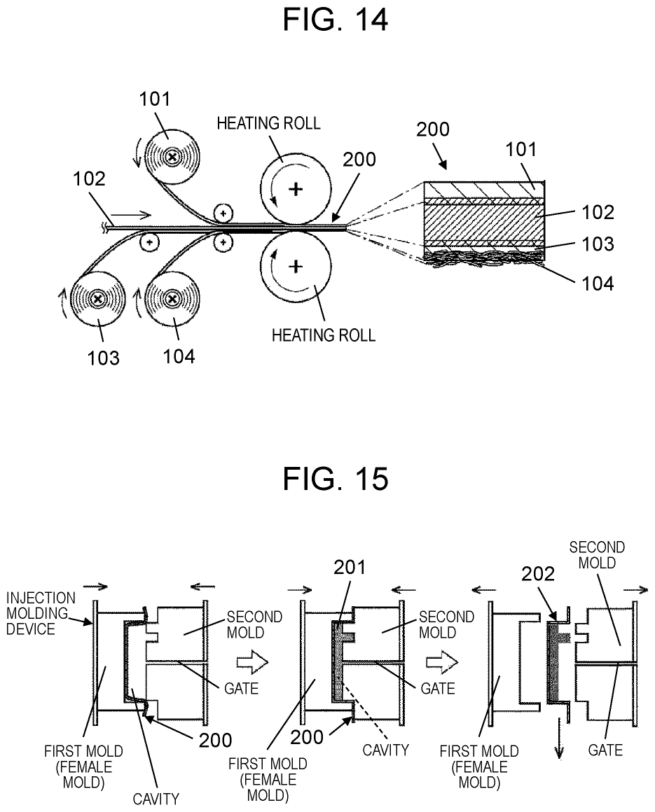

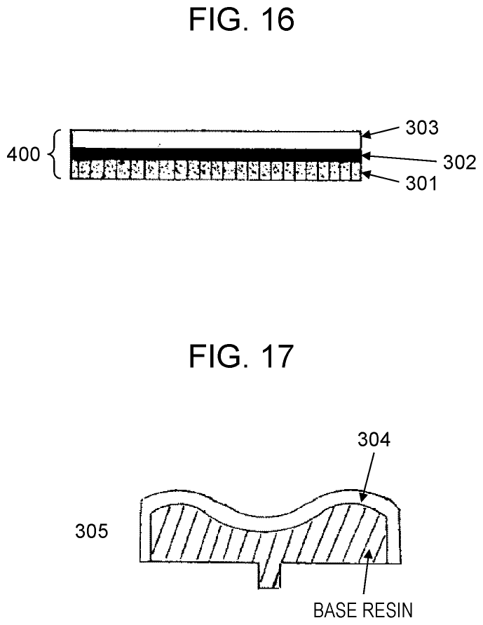

FIGS. 11 and 12 are schematic sectional views illustrating a sectional structure of laminate 32 according to a second exemplary embodiment. Note that those having similar functions as those of the first exemplary embodiment will be denoted by the same reference marks. Laminate 32 illustrated in FIG. 11 is configured as laminate 32 in which decorative layer 1, second adhesive layer 10, primer layer 11, base material layer 12, first adhesive layer 2, and support layer 3 are formed in this order. In laminate 32a of another example illustrated in FIG. 12, decorative layer 1, second adhesive layer 10, primer layer 11, base material layer 12, primer layer 11, first adhesive layer 2, and support layer 3 are formed in this order.

### Second Adhesive Layer

Second adhesive layer 10 is formed for the purpose of bonding decorative layer 1 and base material layer 11. Components of second adhesive layer 10 include, for example, a vinyl chloride-vinyl acetate-based copolymer, an olefin-based resin, a polyolefin-based resin, a urethane-based resin, an acrylic resin, or the like, and are not limited to the above-described materials as long as the purpose of adhesion can be achieved. For the purpose of improving the adhesive strength, it may include a component that forms the crosslinked structure such as a urethane bond. The average film thickness is 3 μm or more and 200 μm or less. When the average film thickness is in the above range, the adhesive thickness is sufficient, and sufficient adhesive strength is obtained. In addition, when the average film thickness is in the above range, the production cost can be suppressed low. The thickness is more preferably 5μm or more and 100 μm or less.

### Primer Layer

Primer layer 11 has a role of firmly bonding base material layer 12 to first adhesive layer 2 or second adhesive layer 10, and is provided on one surface or both surfaces of base material layer 12. For example, when components of first adhesive layer 2 and second adhesive layer 10 are acrylic adhesives, the components can be selected in consideration of compatibility such as providing primer layer 11 of the same acrylic component. In addition, by forming the crosslinked structure such as a urethane bond in primer layer 11, film strength of primer layer 11 itself can be improved, or when first adhesive layer 2 and second adhesive layer 10 have similar components, the crosslinked structure can be formed with each of them, and interlayer adhesive force itself can be greatly improved. Note that when first adhesive layer 2 and second adhesive layer 10 can be directly and firmly bonded to base material layer 12, it is not always necessary to provide primer layer 11.

### Base Material Layer

Base material layer 12 plays a role of improving the shape followability of laminates 32 and 32a and improving durability against appearance defects due to resin heat and pressure during injection molding. The material includes, for example, a general-purpose polymer film generally used as an industrial product such as polyethylene terephthalate, polycarbonate, acrylic, or polyolefin. Base material layer 12 does not need to include only one kind of component, and may be subjected to a treatment in combination with another substance such as easy adhesive coating on one side or both sides thereof. Further, surface modification treatment such as corona treatment or plasma treatment may be performed. Furthermore, base material layer 12 may be subjected to treatment for enhancing designability and functionality. For example, in the case of the designability, printing of a pattern, material coloring of base material layer 12 itself, and the like are exemplified. In the case of the functionality, having an IR/UV cut function, forming an electronic circuit using a conductive material on base material layer 12, or the like are exemplified. In this manner, as long as the original purpose of base material layer 12 is achieved, such as improvement of the shape followability of laminate 32 and improvement of the durability during injection molding described above, other designability and functionality can be imparted without limitation. Note that laminate 32 can be produced by a production method by thermocompression bonding similar to that in FIG. 4 of the first exemplary embodiment, the shaped article can be further produced by hot pressing similarly as in FIGS. 5A to 8B of the first exemplary embodiment, and the molded article can be processed by the method for producing the molded article described above with reference to FIGS. 10A and 10B.

With configuration of the second exemplary embodiment, base material layer 12 is provided between decorative layer 1 and support layer 3, so that the strength of laminate 32 itself can be improved, and laminates 32 and 32a having improved shape followability during the subsequent hot pressing and durability against heat and pressure of the resin during injection molding can be produced.

### Third Exemplary Embodiment

### Molded Article

FIG. 13 is a schematic sectional view illustrating a sectional structure of molded article 13 according to a third exemplary embodiment. Note that those having similar functions as those of the first and second exemplary embodiments will be denoted by the same reference marks. Molded article 13 according to the third exemplary embodiment has a configuration in which laminate 31, third adhesive layer 14, and reinforcing layer 15 formed in a separate step are sequentially laminated and integrated.

### Third Adhesive Layer

Third adhesive layer 14 has an average film thickness of 1 μm or more and 100 μm or less, and the form of a liquid, a sheet shape, a thermoplastic adhesive, a thermosetting adhesive, or the like is exemplified. Components of third adhesive layer 14 may include, for example, a vinyl chloride-vinyl acetate-based copolymer, an olefin-based resin, a polyolefin-based resin, a urethane-based resin, an acrylic resin, or the like, and are not limited thereto as long as the purpose of bonding support layer 3 and reinforcing layer 15 can be achieved. Note that third adhesive layer 14 may be formed in advance on a back surface of support layer 3 of laminate 31, or may be formed in advance on a front surface of reinforcing layer 15.

### Reinforcing Layer

A material of reinforcing layer 15 can be selected according to the application. For example, a general-purpose molded resin such as a PMMA resin, an ABS resin, a PS resin, or a PC resin, a resin for optical use, a super engineering resin, a metal member, a glass member, a ceramic member, a wooden material, or the like can be selected according to a required application, and a process for producing them is not limited. The component of third adhesive layer 14 may be selected according to the material of reinforcing layer 15. Examples of process of integrating laminate 31 and reinforcing layer 15 include hand bonding and vacuum pressure molding, and are not limited as long as laminate 31 and reinforcing layer 15 can be bonded with third adhesive layer 14 interposed therebetween. Note that in the same manner as in the first exemplary embodiment, it is also possible to obtain the molded article in which laminate 31 is wound up to the appearance back surface side by forming a fold in laminate 31 during hot pressing and integrating the laminate with reinforcing layer 15.

In the third exemplary embodiment, although a case of the molded article using laminate 31 according to the first exemplary embodiment is taken as an example, laminates 32 and 32a described above in the second exemplary embodiment can also be integrated with reinforcing layer 15 to form the molded article by a similar process.

### INDUSTRIAL APPLICABILITY

The laminate, the shaped article, and the molded article according to the present disclosure contribute to high functionality and high design in a field requiring decoration such as exterior of various household electrical appliances and in-vehicle interior.

### REFERENCE MARKS IN THE DRAWINGS

1: decorative layer
2: first adhesive layer
3: support layer
4: decorative film
5: decorative pattern layer
6: protective layer
7: base resin
8: molded article
9: molded article
10: second adhesive layer
11: primer layer
12: base material layer
13: molded article
14: third adhesive layer
15: reinforcing layer
21: heat-fusible polyester short fiber (core-sheath structure)
22: polyethylene terephthalate short fiber
23: fusion-bonded portion
24: non-fusion-bonded portion
31, 31a: laminate
32, 32a: laminate
33: positioning tab
34: shaped article
35: positioning pin
36: recess
38: opening surface
51: base material

1. A laminate comprising a decorative layer, a first adhesive layer, and a support layer laminated in this order, wherein
the support layer includes two or more kinds of materials having different melting points including a material having a relatively low melting point and a material having a relatively high melting point, and
a 10% modulus value evaluated as tensile strength at an elongation rate of 10% in a tensile test according to JIS L1913 for a test piece having a width of 25 mm of the laminate is 5 N or more and 23 N or less.

2. The laminate according to claim 1, wherein the material having a relatively low melting point included in the support layer is fused between the materials having a relatively high melting point included in the support layer to form a crosslinked structure.

3. The laminate according to claim 1, wherein the first adhesive layer penetrates into the support layer and is bonded and integrated with the support layer, and the first adhesive layer covers a surface of the support layer.

4. The laminate according to claim 1, wherein a base material layer is formed between the decorative layer and the first adhesive layer.

5. A shaped article comprising a decorative layer, a first adhesive layer, and a support layer laminated in this order, wherein
the support layer includes two or more kinds of materials having different melting points including a material having a relatively low melting point and a material having a relatively high melting point, and
a 10% modulus value evaluated as tensile strength at an elongation rate of 10% in a tensile test according to JIS L1913 for a test piece having a width of 25 mm of the shaped article is 30 N or more.

6. The shaped article according to claim 5, wherein the material having a relatively low melting point included in the support layer is fused between the materials having a relatively high melting point included in the support layer to form a crosslinked structure, and a shape of the shaped article is maintained.

7. The shaped article according to claim 5, wherein a product depth expressed as a length from an opening surface of a recess to a bottom of the recess of the laminate constituting the shaped article is 10 mm or more and 100 mm or less.

8. A molded article comprising:
the shaped article according to claim 5; and
an injection molding resin integrated with the shaped article.

9. A molded article comprising:
one member selected from the group consisting of a resin member, a metal member, a glass member, a ceramic member, and a wooden member; and
the shaped article according to claim 5, the shaped article being bonded to a surface of the member.

10. A method for producing a laminate, the method comprising:
sequentially laminating a decorative layer, a first adhesive layer, and a support layer including two or more kinds of materials having different melting points including a material having a relatively low melting point and a material having a relatively high melting point; and
thermocompression bonding the decorative layer, the first adhesive layer, and the support layer laminated, so that a surface temperature of the support layer is equal to or lower than a melting point of the material having a relatively low melting point.

11. The method for producing the laminate according to claim 10, wherein for a test piece having a width of 25 mm of the laminate obtained in the thermocompression bonding, a 10% modulus value evaluated as tensile strength at an elongation rate of 10% in a tensile test according to JIS L1913 is 5 N or more and 23 N or less.

12. A method for producing a shaped article, comprising:
trimming the laminate according to claim 1 into a predetermined shape; and
positioning, fixing, and hot pressing the laminate trimmed.

13. The method for producing the shaped article according to claim 12, wherein for a test piece having a width of 25 mm of the shaped article obtained in the hot pressing, a 10% modulus value evaluated as tensile strength at an elongation rate of 10% in a tensile test according to JIS L1913 is 30 N or more.

14. A method for producing a molded article, the method comprising:
positioning and fixing the shaped article according to claim 5 in injection molds, and clamping the injection molds;
pouring a resin into a cavity between the injection molds in a state where the injection molds are clamped; and
opening the injection molds after the resin is cured and taking out a molded article obtained by integrating the shaped article and the resin cured.

15. A method for producing a molded article, the method comprising obtaining a molded article obtained by bonding the shaped article according to claim 5 to a surface of one member selected from the group consisting of a resin member, a metal member, a glass member, a ceramic member, and a wooden member.
